(19) United States
(12) Patent Application Publication
(10) Pub. No.: US 2008/0224080 A1
(43) Pub. Date: Sep. 18, 2008

(54) Beverage Dispense Valves

(76) Inventor: Simon Robert Miller, West Midlands (GB)

Correspondence Address: MESCHKOW & GRESHAM, P.L.C., 5727 NORTH SEVENTH STREET, SUITE 409, PHOENIX, AZ, 85014, US

(21) Appl. No.: 12/065,138

(22) PCT Filed: Aug. 21, 2006
(86) PCT No.: PCT/IE2006/000090

§ 371 Date: Feb. 28, 2008

(30) Foreign Application Priority Data
Sep. 9, 2005 (IE) S2005/0590

(51) Int. Cl. B67D 1/14

(52) U.S. Cl. 251/245; 222/563

(57) ABSTRACT

A beverage dispense valve is described comprising (i) a body [2] having a bore defining a cylindrical chamber [15] therein and having a beverage inlet port [19] and a beverage outlet port [18] in communication with the chamber; (ii) a rotatable valve member [3] comprising a generally cylindrical barrel of plastics material rotatably mounted in the chamber [15] in the body [2] so as to be movable between open and closed positions of the valve, said barrel having a conduit therein to allow fluid to flow between the beverage inlet port [19] and the beverage outlet port [18] when the valve is in an open position, the external diameter of the barrel being minimally less than the internal diameter of the bore in the body; and (iii) handle means [8] to rotate the valve member [3] between the open and closed positions by engagement with the end faces of the valve member [3]; the handle [8] comprising a fork assembly having at least two cover plates [1,1A] to cover the end faces of the valve member [3]; characterised in that an inner surface of at least one cover plate is configured to releasably engage the valve member [3] in a single orientation such that in the open position of the valve, the fluid conduit connects the beverage inlet port [19] to the beverage outlet port [18]. The beverage dispense valve described is a user friendly beverage dispense valve which is convenient both to assemble and to dis-assemble for service in-situ and which is more appealing to the eye.

### FIELD OF THE INVENTION

This invention relates to valves for dispensing liquids. It is useful, inter alia, in the field of beverage dispensing equipment, particularly for dispensing beers, especially draught beers supplied from a pressurised container. The background of the invention will be discussed with reference to beverage dispensing taps, but the invention is not so limited.

### BACKGROUND TO THE INVENTION

Beverage dispensing taps with rotary valves are known. The handle is attached by means of a forked lower end to a cylindrical valve member which is rotatable in a generally cylindrical cavity inside a tap body. The tap body is constructed with a beverage inlet port and a beverage outlet port. When the handle is in the vertical closed position, there is no communication between the beverage inlet port and beverage outlet port. A connection between the beverage inlet port and the beverage outlet port is made when the handle is pulled from the vertical closed position to the angular open position by means of a channel in the lower section of the valve member. When the handle is in the vertical position and the beverage inlet port is closed the beverage flow is sealed by a plug which is urged radially outward from the valve member. The plug is one of a pair of plugs installed at either end of a passage extending across the valve member. The plugs are sustained in an outwardly urged direction by means of a spring tension created equally in the centre of the valve member, the tension between the plugs is required to be constant and within a narrow band of pressure to maintain minimal wear of the plugs and consistent sealing against the beverage flow at the beverage inlet port when the handle is in the vertical position and the beverage tap is closed.

Belgian Patent Nos: BE 840635 and 1014231 of ETS. Antoine describe taps with a rotary valve using two plugs that are urged outwardly by means of a coil spring. However, the use of a coil spring has certain disadvantages, as set out in Irish Patent No: S81460, which shares a common inventor with the present application, and whose contents are incorporated herein by reference.

Irish Patent No. S81460 describes a beverage dispensing tap comprising:
{A} a body defining a cylindrical chamber therein and having a beverage inlet port and a beverage outlet port;
{B} a rotatable valve member comprising a generally cylindrical barrel fitting closely in the said chamber in the body and having a channel therein to provide a conduit between the inlet port and the outlet port when the valve is in an open position;
{C} handle means to rotate the valve member between closed and open positions; and
{D} sealing means receivable in a cylindrical passage in the valve member and comprising a pair of plugs which fit slidably at either end of the passage, and spring means between the two plugs urging them outwardly of the valve member characterised in that the spring means comprise a plurality of disc springs.

Beverage dispensing taps with a rotary valve as described above were made using a tap body and a rotatable valve member of stainless steel or nickel plated brass, while the diametrically opposed plugs of the sealing means were of a plastic material. In order to facilitate a smooth rotary movement, consistent sealing life and no friction between the metal components acting on one another, it was necessary to provide a reasonable clearance between the external surface of the valve member and the internal surface of the chamber in the tap body. For example in the tap of IE S81460 a clearance of about 0.5 mm between the external diameter of the valve member and the internal diameter of the tap body was required. The necessity to have a clearance gap between the outer diameter of the rotary valve member and the receiving internal diameter of the tap body creates an area susceptible to contamination. Beverage being dispensed can leak into this clearance when the rotary valve member is operated, thus leading to infection build-up. This is highly undesirable and it is necessary to strip down the beverage dispense tap to facilitate cleaning to ensure hygiene is maintained.

Furthermore, the prior art valves applied high tension in the spring means to ensure valve sealing against the beverage flow at the beverage inlet port. In this construction the rotary valve member cannot be removed in-situ without special tools and therefore requires to be returned to the manufacturer for stripping, cleaning and re-assembly.

Irish Patent Application No: S2002/0867, which also shares a common inventor with the present application, and whose contents are incorporated herein by reference, describes a beverage dispensing tap comprising:
{A} a body having a bore defining a cylindrical chamber therein and having a beverage inlet port and a beverage outlet port in communication with the chamber;
{B} a rotatable valve member comprising a generally cylindrical barrel of plastics material rotatably mounted in the chamber in the body so as to be movable between open and closed positions of the valve, the said barrel having a channel therein to provide a fluid conduit between the inlet port and the outlet port when the valve is in an open position, and having a sealing surface portion to seal one of the ports when the valve is in the closed position, the external diameter of the barrel being minimally less than the internal diameter of the bore in the body;
{C} handle means to rotate the valve member between the open and closed positions;
{D} at least one plug of a plastics material receivable in a recess in the barrel diametrically opposite to the sealing surface portion; and
{E} spring means in the recess to urge the plug radially outwardly of the barrel against the surface of the bore and thus press the sealing surface portion of the barrel against the surface of the bore surrounding the port to be sealed.

Beverage dispensing taps with a rotary valve as described in Irish Patent Application No. S2002/0867 were made with a tap body of stainless steel and a rotatable valve member of a plastic material. By using different materials in the tap body and the rotary valve member the gap between the two parts is maintained at a minimum, eliminating the opportunity for contamination between the external diameter of the rotatable valve member and the receiving internal diameter of the tap body, thus reducing friction between the parts and facilitating easy manual ejection when the tap required disassembly for cleaning in-situ. However, it has been found that the manufacturing tolerances required to match the curvature between the external radial surface portion of the rotatable valve and internal radial surface portion of the tap body is difficult to maintain consistently and the valve has a tendency to fail leak tests during final assembly.

In addition, problems have been experienced during re-assembly of the tap after servicing. Due to the symmetrical construction of the tap body and the rotatable valve member it is possible to incorrectly assemble the rotatable valve member in the tap body. This results in the channel that provides the communication between the beverage inlet port and the beverage outlet port being located in the uppermost portion of the tap body instead of the lower part. Thus while the valve can be reassembled, it will not operate once service is complete due to the incorrect alignment.

Furthermore the tap described in E S2002/0867 requires multiple components for assembly. For example, it requires four screws and two drive plates to operate the rotatable valve member from the closed to open position. While this construction gives high security to handle movement it has limited aesthetical appearance. In addition it is not very user friendly and somewhat reduces the advantages of servicing the tap in-situ due to the number of parts required to be removed when completing this procedure.

There are other known types of beverage dispense tap with ball and rotary valves. In one type a ball valve mechanism is employed where a central bore is turned through 90° to align the bore with opposed inlet and outlet ports. Another known type of similar valve uses a ball with an arcuate channel which provides a conduit between inlet and outlet ports orientated at 90° to each other. However in these forms of valve the ball is rotatably housed in plastics shell components that are machined to fit the ball surface and then secured tightly around it. Both these forms of valve cannot be disassembled in-situ as adhesive is used to seal the threads that secure the valve mechanism, with the result that the dispense tap cannot be serviced once installed in trade.

It is an object of the present invention to provide an improved beverage dispense valve in which the problems described above are reduced or eliminated. It is also an object of the invention to provide a reliable and more user friendly beverage dispense valve which is convenient both to assemble and to dis-assemble for service in-situ and which is more appealing to the eye.

### SUMMARY OF THE INVENTION

Accordingly, the invention provides a beverage dispense valve comprising:
(i) a body having a bore defining a cylindrical chamber therein and having a beverage inlet port and a beverage outlet port in communication with the chamber;
(ii) a rotatable valve member comprising a generally cylindrical barrel of plastics material rotatably mounted in the chamber in the body so as to be movable between open and closed positions of the valve, said barrel having a conduit therein to allow fluid to flow between the beverage inlet port and the beverage outlet port when the valve is in an open position, the external diameter of the barrel being minimally less than the internal diameter of the bore in the body; and
(iii) handle means to rotate the valve member between the open and closed positions by engagement with the end faces of the valve member; the handle comprising a fork assembly having at least two cover plates to cover the end faces of the valve member;
characterised in that
an inner surface of at least one cover plate is configured to releasably engage the valve member in a single orientation such that in the open position of the valve, the fluid conduit connects the beverage inlet port to the beverage outlet port.

The bore in the body suitably defines an open-ended cylindrical chamber. Preferably the chamber is open at both ends so that the valve member can be pushed out of it if the unit is to be disassembled.

The chamber may suitably be closed by the handle fork assembly covers applied to either side of the body at each end of the bore. The handle fork assembly can only be secured in a singular orientation when attached to the valve member so that when it is located within the receiving cylindrical chamber of the body the conduit can only be located in the lowermost portion of the cylindrical chamber of the body so that it connects the beverage inlet port and the beverage outlet port when the tap is in the open position, This facilitates correct alignment of the valve during assembly.

At least one cover plate and at least one end of the valve member may suitably be provided with a mutually interengageable boss and recess, the recess being offset with respect to the axis of the cylindrical valve. This creates a configuration suitable to achieve the desired orientation of the valve member in the bore. Preferably the recess is offset from the axis above or below the axis, particularly above the axis, when the valve is in the closed position. Preferably each of the cover plates and each of the ends of the valve member are provided with a boss and a co-operating offset boss. This symmetrical arrangement facilitates assembly and increases the engagement between the components.

Preferably, at least one cover plate and at least one end of the valve member are provided with a mutually interengageable drive plate portion and drive channel. More preferably, each of the cover plates and each of the ends of the valve member are provided with a drive plate portion and a co-operating drive channel. This makes the drive contact between the components symmetrical.

Suitably at least one end face of the barrel of said valve member is provided with a channel and a recess, the recess being offset with respect to the axis of the barrel, and the inner surface of at least one cover plate of the handle fork assembly has a configuration comprising a drive plate portion and a boss adapted to releasably engage said channel and recess of the valve member in a single orientation. Preferably the recess is located on a centre line (diameter) of the barrel. Most suitably the recess is located within the channel, particularly in the base thereof. Preferably both end faces of the barrel are provided with a channel and a recess and both cover plates are configured with a drive plate portion and a boss. This increases the drive contact between the handle assembly and the valve member.

Preferably each boss is a close fit in the co-operating recess. Desirably, each drive plate portion is a close fit in the co-operating slot. These features contribute to positive drive contact between the handle fork assembly and the valve member.

Suitably, the handle fork assembly further comprises two releasably interlocking arms to retain the cover plates in contact with the valve member. Thus the handle fork assembly does not require screws or fasteners for assembly. The cover plates of the fork assembly do not contain screws or fasteners. Suitably the cover plates comprise parallel drive plate portions on the inner surface and extended offset location bosses that match with receiving parallel slots and cylindrical recesses situated at the outer end faces of the valve member.

Preferably, the bore of the body has open ends, and the body defining at least one open end of the bore is provided with diametrically opposed cut-out portions adapted to receive a portion of the drive plate of the co-operating cover plate of the handle fork assembly such that in use, the cut-out portions define the degree of movement of the handle between the open and closed position of the valve member.

The cut-out portions at either open-end of the cylindrical chamber are inward of the handle fork assembly covers and are suitable to locate the inner parallel drive plates of the handle fork assembly covers so that as the handle fork assembly is operated, they define the open and closed position of the valve member, ensuring communication between the beverage inlet port and the beverage outlet port when open, and sealing against the beverage inlet port when closed.

Further preferably, the cover plates of the handle fork assembly comprise an outer part-spherical surface such that in use, the outer surface of the cover plates and the valve body (other than the portions forming the inlet and outlet ports) has a substantially spherical profile.

The beverage dispense valve suitably further comprises at least one spring-urged plug means located in a passage in the barrel to effect sealing at the inlet port when the valve is in the closed position.

Preferably the spring means comprises a pair of plugs which fit slidably at either end of the passage, and spring means between the two plugs urging them outwardly of the valve member to effect a sealing at the inlet port when the valve is in the closed position.

The valve member may suitably be provided with one cylindrical passage receiving two spring-urged plugs diametrically opposite so that one plug effects a seal at the inlet port when the valve is in the closed position.

The spring may be a plurality of disc springs. However, preferably, the spring comprises a food grade elastomeric material. Suitable elastomeric materials include those that have excellent resilient properties, that is, they have the ability to return to their original shape even when under constant deformation, including compression in a wet environment.

The spring most suitably comprises a composition of polychloroprene rubber such as sold under the trade name neoprene, or a similar form of synthetic rubber compound of the polychloroprene family or a suitable food grade approved elastomer composite, including a fluoroelastomer such as sold under the Trade Mark Viton or organic compounds such as nitrile rubber, so that equal pressure is simultaneously applied to both plugs when the valve member is located within the cylindrical bore of the body and the two spring-urged plugs are forced inward.

The spring is preferably a disc, although another shape such as doughnut shape could be used. The spring is suitably formed of solid elastomeric material.

The use of an elastomeric material as a spring in a rotary beverage dispense valve is novel and inventive in itself and may be applied to other dispense valves including the prior art taps described above. Whereas the use of either coil springs or disc springs involves an accumulation of tolerances that must be taken into account, the use of a spring of elastomeric material has the advantage that the pressure on the plug(s) can be maintained more accurately.

In a preferred embodiment each of the plugs of the valve member is provided with an alignment slot such that in use the plugs are assembled with their surfaces in alignment with the outer cylindrical surface of the valve member.

Preferably, the two plugs each comprise an alignment slot located perpendicular through the centre line of the plug on a radius of the outer arcuate sealing surface of the plug.

Suitably, the valve member further comprises two alignment holes situated at one end of the outer flat surface of the valve member whereby the alignment holes correspond to the slots of the plugs, so that when the plugs are assembled into the valve member in an assembly jig containing two alignment pins, the arcuate surfaces of the plugs are assured to be in perfect coherence with the outer surface of the valve member. This means that when the plugs and valve are assembled, the centre line of the outer curved surface of the each plug is perfectly aligned to the centre line axis of the barrel of the valve member so that the outer curved surface of the plug completes the outer cylindrical curved surface of the barrel of the valve member when the valve member assembly is inserted into the tap body and the plugs are compressed inwardly against the spring. This ensures perfect sealing when the valve is assembled into the receiving cylindrical bore of the body.

The minimal difference between the external diameter of the valve member and the internal diameter of the receiving tap body bore should preferably provide the smallest clearance that permits smooth rotation of the valve member when the handle assembly is actuated. This provides excellent sealing of the beverage inlet port when the handle is in the closed position and minimal capillary between the external diameter of the valve member and the internal diameter of the chamber of the tap body. The difference in diameters is preferably less than 0.10 mm, and may suitably be in the range from 0.05 to 0.07 mm, particularly from 0.055 to 0.065 mm.

Preferably the body and the valve member comprise different materials. Suitably the body comprises metal, particularly stainless steel, while the valve member comprises plastics material. If the body is of plastics material also, it is preferably of a different plastics material from the valve member. Suitably the valve member is of a plastic material with very good creep resistance, low and constant co-efficient of friction and physically inert, thus suitable for food contact.

In one aspect, this application relates to a beverage dispense valve comprising
(i) a body having a bore defining a cylindrical chamber therein and having a beverage inlet port and a beverage outlet port in communication with the chamber;
(ii) a rotatable valve member comprising a generally cylindrical barrel of plastics material rotatably mounted in the chamber in the body so as to be movable between open and closed positions of the valve, said barrel having a conduit therein to allow fluid to flow between the beverage inlet port and the beverage outlet port when the valve is in an open position, the external diameter of the barrel being minimally less than the internal diameter of the bore in the body;
(iii) handle means to rotate the valve member between the open and closed positions; and
(iv) sealing means receivable in a cylindrical passage in the valve member and comprising a pair of plugs which fit slidably at either end of the passage, and spring means between the two plugs urging them outwardly of the valve member; characterised in that the spring means comprises a food grade elastomeric material.

In this aspect the spring means may comprise a composition of a polychloroprene rubber such as sold under the trade name neoprene.

### BRIEF DESCRIPTION OF THE DRAWINGS

One embodiment of the invention will now be described with reference to the accompanying drawings in which:

FIG. 1 is a front elevation of the beverage dispense valve [BDV] in the closed position;

FIG. 2 is a vertical cross-section of the side elevation of the BDV in the closed position, on a line equivalent to A-A in FIG. 1;

FIG. 3 is a front elevation of the BDV in the open position;

FIG. 4 is a vertical cross-section of the side elevation of the BDV in the open position, on a line equivalent to B-B in FIG. 3;

FIG. 5 is a partially exploded front elevation of the BDV defining the handle fork assembly covers and the handle assembly;

FIG. 6 is a horizontal cross-section of the BDV with the rotatable valve member in the closed position, on a line equivalent to C-C in FIG. 5;

FIG. 7 is a view of the right hand handle fork cover, on a line equivalent to D-D in FIG. 5;

FIG. 8 is a side elevation of the BDV in the closed position

FIG. 9 is a vertical cross-section of the front elevation of the BDV in the closed position, on a line equivalent to E-E in FIG. 8;

FIG. 10 is a partial side view (omitting the handle means) of the BDV in the closed position showing the relationship between the rotatable valve member and the body;

FIG. 11 is a partial side view (omitting the handle means) of the BDV in the open position showing the relationship between the rotatable valve member and the body;

FIG. 12 is an exploded view of the lower elevation of the rotatable valve member assembly;

FIG. 13 is an exploded view of the side elevation of the rotatable valve member assembly;

### DETAILED DESCRIPTION OF THE DRAWINGS

The drawings and the description herein define only the valve assembly and its operation and are not concerned with the location of the BDV with the various forms of complementary fixing attachments, commonly known as shank assemblies. For the sake of brevity, the BDV shown demonstrates one such fixing option that utilises a pitched spline attachment [23] in the body [2] which has a face located seal [14] at the beverage inlet port [19] so that a matching flat faced shank assembly [not shown] would be located, fastened and sealed onto the BDV by means of screw attachment of a suitable tap locking nut {not shown} onto the body thread [24]. In practice other fixing attachments such as pipe threads, snap couplers etc. could also be used for this purpose and these attachments would be commonly understood by someone skilled in the art of beverage dispense valves.

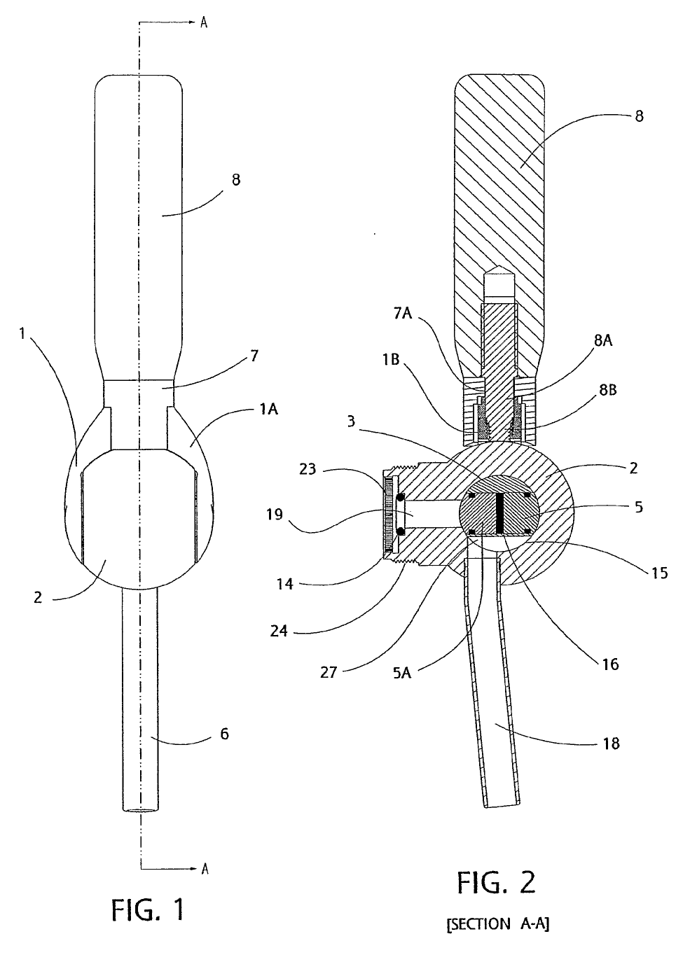

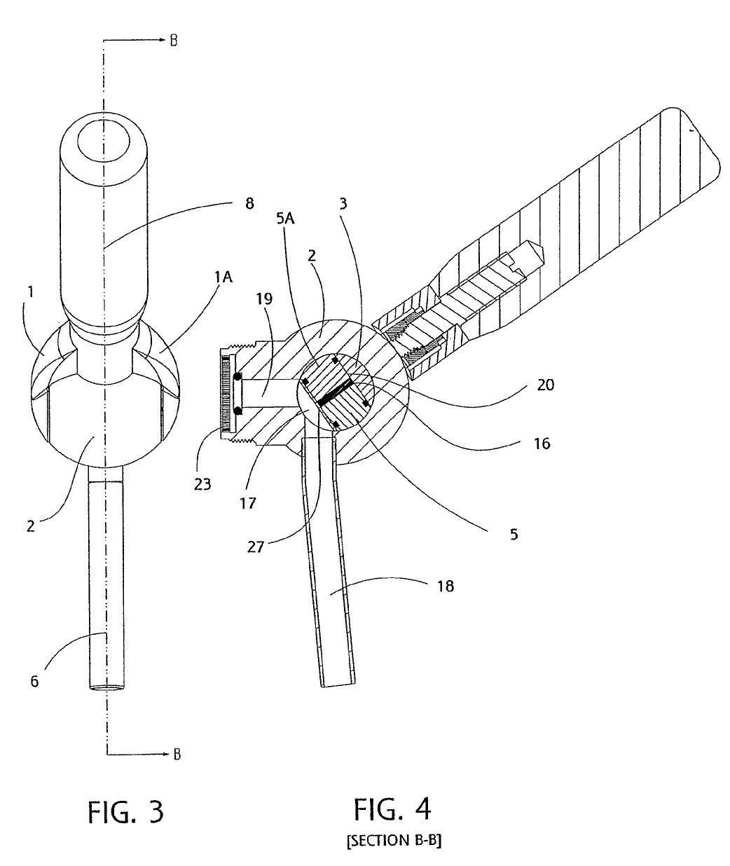

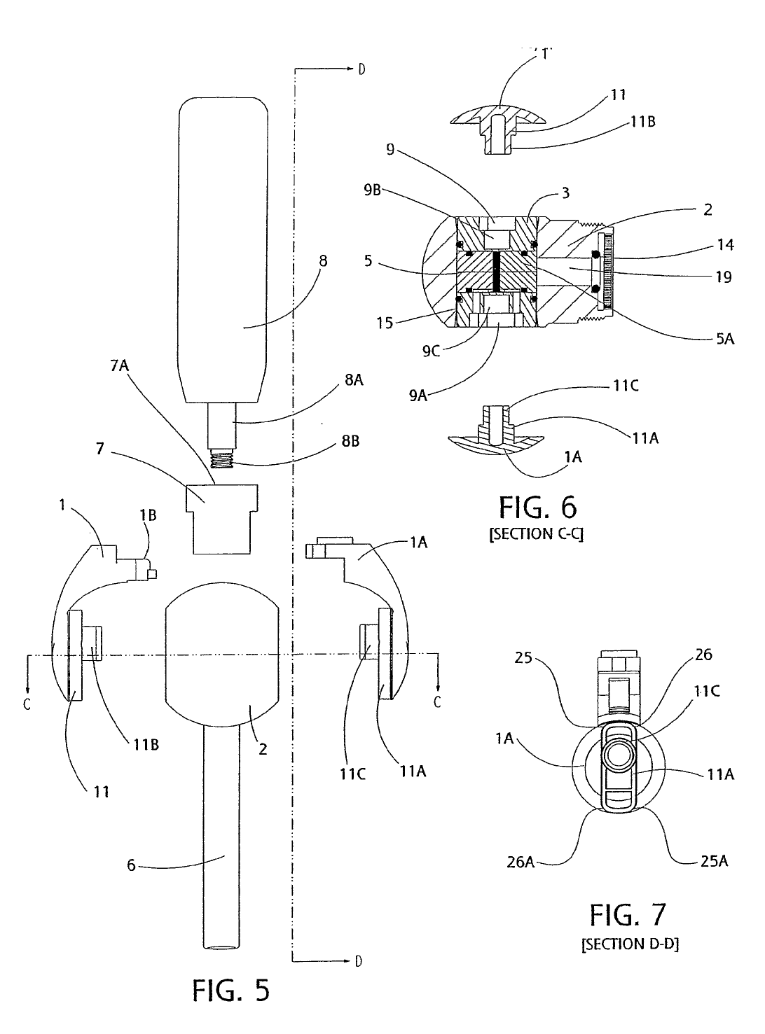

As shown particularly in FIGS. 1, 2 and 9 of the drawings, a BDV comprises a handle [8], a body [2] and a valve member [3]. The length of the valve member [3] is equal to the width of the body [2]—see FIG. 6. The handle assembly compromises a handle [8], to operate the BDV from open to closed position, with a journal diameter portion [8A] and an external fastening thread [8B] at the lower end thereof. The handle supports a pair of handle fork assembly covers [1&1A] by aligning the journal diameter portion [8A] through a suitable receiving diameter [7A] in a support brace [7]. The pair of handle fork assembly covers [1&1A] are then secured by means of the fastening thread [8B] which is screwed into the internally-threaded receiving portion [1B] of the lower handle fork assembly cover [1A] so that front and rear depending wing portions of the support brace [7] envelop the joint of the handle fork covers [1&1A]—see FIG. 2. As shown particularly in FIGS. 5, 6, 7 and 9 the handle fork assembly covers [1&1A] are provided with a pair of drive plate portions [11&11A] which engage in the parallel slots [9&9A] of the valve member [3]. As seen in FIG. 7, each of the drive plate portions has a web structure. The threaded engagement of the handle assembly [8,8A,8B] with the fork assembly [1&1A] creates a simple means to lock the handle fork assembly covers [1&1A] and can be assembled and disassembled to allow release of the assembly covers and thus to allow easy removal of the valve member without fasteners or tools.

As shown particularly in FIGS. 2 and 4, the valve member [3] is positioned within a cylindrical bore [15] and transversely located within the body [2] with an open channel [27] in the downward position. The valve member contains two plastic material plugs [5&5A] that are located transversely in a cylindrical passage [20] within the valve member [3] so that when the valve member [3] is positioned within the body [2] so that no protrusion of the valve member [3] is visible either side of the body [2] the sealing plug [5A] is positioned directly against and circumferentially concentric around the diameter of the beverage inlet port [19] thus preventing beverage from flowing through the valve.

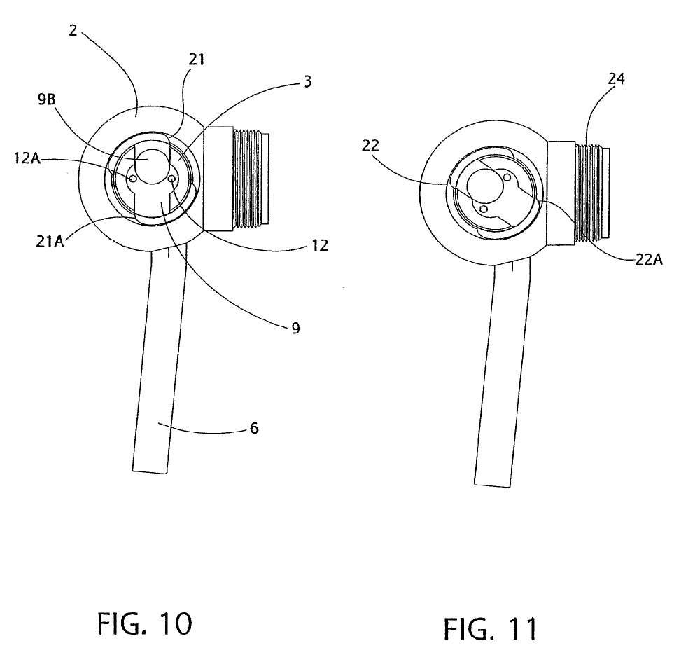

The handle fork covers [1&1A] are precision cast with a locating and securing configuration on their inner faces to ensure correct alignment and security with the valve member [3] when assembling. With reference to FIGS. 5 and 6, the casting is provided with a pair of drive plate portions [11&11A] situated on the inner surfaces of the handle fork cover plates [1&1A] which locate in the parallel slots [9&9A] of the end faces of the valve member [3]. Each drive plate portion is a close fit in the co-operating slot. The casting is also provided with a pair of centre line offset male bosses [11B&11C] which align respectively with a pair of centre line offset female recesses [9B&9C] when the handle fork covers are attached to the valve member [3] located within the body [2]. Each of the bosses is on the centre longitudinal line of the respective handle fork assembly, i.e. the substantially vertical centre line when the handle is in the closed position, and is offset above the axis of the valve member in the assembled condition of the tap. The boss is aligned with the drive plate portion and projects axially therefrom. Each of the recesses is on the diametrical centre line of the valve member, i.e. the substantially vertical centre line when the valve is in the closed position (see FIG. 10), and is offset above the axis of the valve member in the correctly assembled condition of the tap. The recess is located in the base of the slot [9&9A]. Each boss is a close fit in the co-operating recess. When the handle fork covers [1&1A] are assembled onto the valve member [3] the drive plate portions [11&11A] and the offset male bosses [11B&11C] are equally encompassed within the body [2] so that the valve member [3] is completely contained therein, as in FIG. 9.

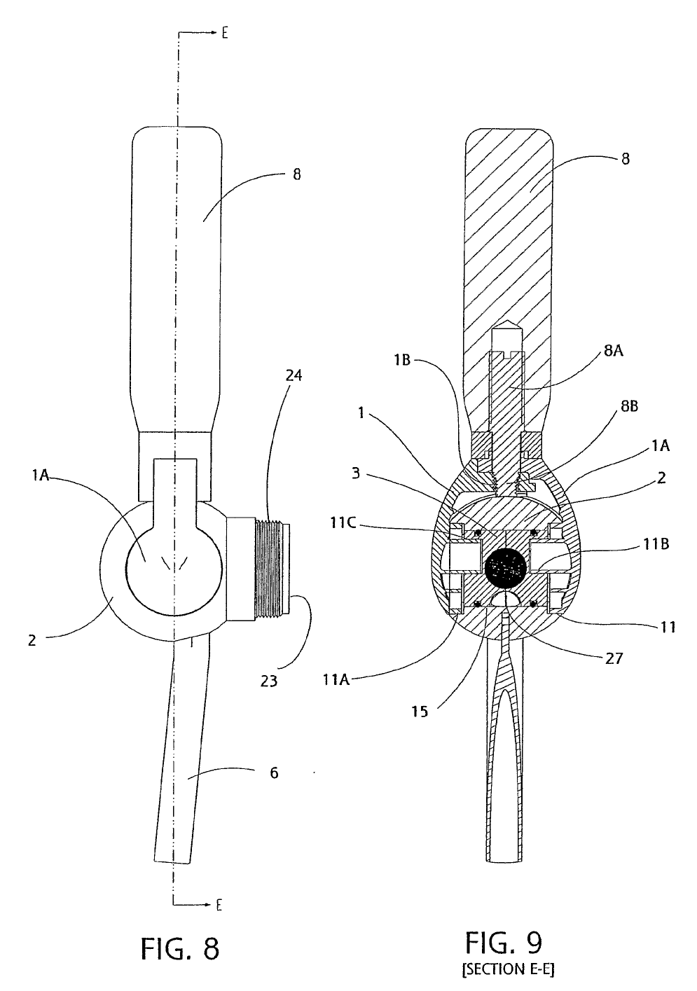

The valve member [3] is generally cylindrical and the receiving bore [15] of the body (2) is similarly cylindrical. The valve member can therefore be located throughout 360 degrees within the body. It is necessary to ensure correct orientation of the valve member [3] within the body bore [15]. With reference to FIGS. 6, 8 and 9, the centre line offset male bosses [11B&11C] engaging with the aligning pair of female recesses [9B&9C] ensure that the handle fork assembly and the valve member [3] can only be assembled if the valve member has been inserted into the bore correctly, with the liquid flow channel [27] positioned in the lower portion of the BDV when fully assembled, see also FIG. 9. Then orientation of the valve member in the bore can be checked visually by an operative seeing that the recesses [9B&9C] are higher than the axis of the valve member [3]—see FIGS. 10 and 11.

In this embodiment the sealing plug [5A] (see FIG. 2) is urged outward toward the beverage inlet port [19] by means of a spring action created by a rubber composite, most suitably a Neoprene type material acting as a spring [16] located centrally in the cylindrical passage [20] of the valve member [3]. The spring [16] is a solid elastomeric disc and is equidistant between the outer surfaces of the sealing plug [5A] and the opposing plug [5] so as to ensure excellent equilibrium of the valve member [3] within the body [2] during the rotational movements of the handle [8] and very good sealing pressure against the pressurised beverage liquid flow entering the body [2] at the beverage inlet port [19].

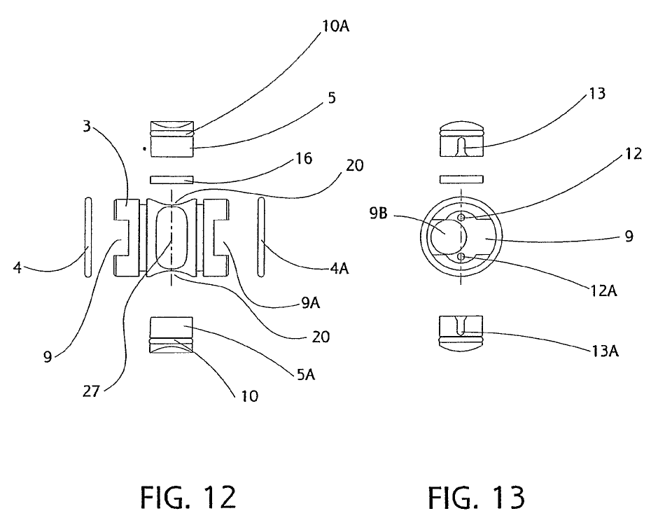

As shown in FIGS. 6 and 12, each plug [5&5A] is generally cylindrical and located within a cylindrical recess [20] of the valve member [3]. Each plug contains an O-ring seal [10&10A] held in a groove close to the arcuate sealing surface of the plugs [5&5A] to prevent liquid from entering the area of the spring [16]. Each plug [5&5A] may suitably be made from a plastic material with very good creep resistance, low and constant co-efficient of friction and physically inert, permissible for food contact, suitably PTFE or preferably Ultra High Molecular Weight Polyethylene (UHMWPe).

When the handle [8] is actuated from the closed to open position, as seen in FIG. 2 and FIG. 4, the valve member [3] is rotated by means of the drive plate portions [11&11A] of the handle fork assembly covers [1&1A] driving the parallel slots [9&9A] which are located in the end faces of the valve member [3] and which are located perpendicular to the beverage flow path [17]. When the valve member is in the closed position as shown in FIG. 2 the sealing plug [5A] seals the valve member at the beverage inlet port [19] preventing beverage flow through the body [2]. When the valve member is in the open position as shown in FIG. 4, the sealing plug [5A] is rotated clockwise by means of the valve member [3] rotating within the cylindrical chamber [15] of the body [2] breaking the seal at the beverage inlet port [19] so that the beverage flow can evacuate through the beverage flow channel [17] and out of the body through the beverage outlet port [18]. The beverage outlet spout [6] forms the beverage outlet port [18].

The valve member [3] is a generally cylindrical barrel which fits within the bore [15] of the body [2], so as to be rotatable therein. Due to the open ends of the bore, the barrel can be inserted into the bore from either end and can be pushed out again if disassembly of the valve becomes necessary for maintenance purposes.

As shown in FIG. 12, the valve member [3] has a channel [27] providing a liquid flow conduit between the beverage inlet port [19] and the beverage outlet port [18] in the open position of the valve. The base of the channel [27] forms a chord to the circumference of the valve member [3] thus ensuring a smooth passage is created in the flow channel [17] for the beverage flow when the valve is open (see FIG. 4).

The beverage inlet port [19] and beverage outlet port [18] are suitably within a diameter range of 6 mm to 12 mm, dependant on the liquid to be dispensed. The channel [27] has a diameter corresponding to that of the beverage inlet port [19] and the beverage outlet port [18], for example in the range of 6 mm to 12 mm. As seen in FIGS. 4 and 9, the channel [27] is approximately semi-circular in profile.

The valve member [3] has a pair of circumferential grooves to receive a pair of o-ring sealing rings [4] and [4a] (see FIG. 12) which seal against the internal wall of the bore [15] acting to steady the valve member [3] in the cylindrical bore [15] during handle actuation from open to closed position.

The body [2] can be made of any suitable food-grade plastic material or food-grade metal, for example nickel or chromium-plated brass, or preferably a grade of Austenitic stainless steel S304 or S316. The valve member [3] can be made from any food-grade plastic with high wear resistance, suitably PTFE or preferably “Ultra High Molecular Weight Polyethylene” {UHMWPe}. The beverage spout [6] can be constructed from any food-grade plastic or food-grade metal, for example nickel or chromium-plated brass or preferably a grade of Austenitic stainless steel S304 or S316.

FIGS. 7, 10 and 11 show the device for limiting the angular rotation of the valve member. In S2002-0867 the invention improved on existing prior art by encompassing the drive plates, which restrict the movement of the handle from closed to open, inside a cut-out recess in the outer open ends of the body whilst attaching with the parallel slots of the valve member, thus eliminating the possibility for dirt to enter the valve member location improving the hygiene qualities of the valve. However, this design relied on the use of four screws to secure the drive plates with the handle mechanism and this had aesthetic limitations as the assembled valve appeared less attractive than that achieved with the original IES81460. In the preferred embodiment of the present invention, the drive plate portions [11&11A] are integral with the investment cast fork covers, which in the parts covering the ends of the valve member have an attractive outer part-spherical appearance to blend with the spherical contour of the body giving an entirely more appropriate feature when the valve is assembled. The drive plate portions [11&11A], when inserted into the valve member parallel slots [9&9A] rotate the valve member [3] within the body [2] with rotational movement from open to close being limited by the contact made between the upper segment [25&26] and lower segment [26A&25A] of the drive plate portions and the profiled cut-out recesses in four positions [21,21A,22&22A] in the open ends of the body [2]. When the valve is in the closed position the upper segment [25&26] of the drive plate [11A] is in contact at [25] with the end position of the cut-out recess [21] of the body [2] and likewise the lower segment [25A&26A] of the drive plate portion [11A] is in contact at [25A] with the end position of the cut-out recess [21A] of the body [2]. When the valve is in the open position, actuated by a forward motion of the handle and fork assembly, the drive plate portions [11&11A] rotate so that the upper segment [25&26] of the drive plate portion [11A] rotate with the valve member [3] until the upper segment of the drive plate [26] contacts the end position of the cut-out recess [22] and likewise the lower segment of the drive plate portion [26A] contacts the end position of the cut-out recess [22A] defining the extremities of the total handle movement required to actuate the valve. The description herein defines one side of the assembly however the principle applies to both handle fork covers [1&1A] as they are symmetrical in design in the drive plate portions and their relationship with the valve member parallel slots and the body cut-out recesses is identical on both sides of the body as seen in FIG. 9.

It is desirable that the assembly of the valve can be performed with speed and accuracy. In previous inventions IES81460 and S2002/0867 the valve assembly utilised disc springs to pressurise the sealing plugs and these components were inserted into cylindrical ports in the valve member. This assembly operation required skilled assembly operatives with a keen eye to align the curved faces of the sealing plug with the curvature of the outer diameter of the valve member so that the curved faces of the sealing plugs, when fully assembled and inserted into the body, complete the diameter of the valve member. With this prior art construction the failure rate, due to misalignment and subsequent leakage, at the final pressure test was unacceptably high and required 20% re-work of the valve assembly.

To overcome the possibility of misalignment one feature of the present invention addresses the possibility of assembly error through the use of an assembly alignment system. Two dowel pins (not shown) which locate inside the valve member [3] through two receiving holes [12&12A], located in one end face of the valve member, extend into the cylindrical passage [20] of the valve member with enough protrusion so that when the sealing plugs are assembled into the cylindrical passage [20] the sealing plug location slots [13&13A] align with the two dowel pins positioned in the dowel pin holes [12&12A] respectively, thus ensuring correct alignment of the curved surfaces of the sealing plugs [5&5A] with the curved outer surface of the valve member [3] ensuring a right-first-time seal between the two surfaces. This alignment system could also be used with the prior art taps.

1. A beverage dispense valve comprising
(i) a body having a bore defining a cylindrical chamber therein and having a beverage inlet port and a beverage outlet port in communication with the chamber;
(ii) a rotatable valve member comprising a generally cylindrical barrel of plastics material rotatably mounted in the chamber in the body so as to be movable between open and closed positions of the valve, said barrel having a conduit therein to allow fluid to flow between the beverage inlet port and the beverage outlet port when the valve is in an open position, the external diameter of the barrel being minimally less than the internal diameter of the bore in the body; and
(iii) handle means to rotate the valve member between the open and closed positions by engagement with the end faces of the valve member; the handle comprising a fork assembly having at least two cover plates to cover the end faces of the valve member;
characterised in that
an inner surface of at least one cover plate is configured to releasably engage the valve member in a single orientation such that in the open position of the valve, the fluid conduit connects the beverage inlet port to the beverage outlet port.

2. A beverage dispense valve according to claim 1 wherein at least one cover plate and at least one end of the valve member are provided with a mutually interengageable boss and recess, the recess being offset with respect to the axis of the cylindrical valve member.

3. A beverage dispense valve according to claim 1 or 2 wherein at least one cover plate and at least one end of the valve member are provided with a mutually interengageable drive plate portion and drive channel.

4. A beverage dispense valve according to any one of claims 1 to 3 wherein at least one end face of the barrel of said valve member is provided with a channel and a recess, the recess being offset with respect to the axis of the barrel; and wherein the inner surface of at least one cover plate of the handle fork assembly has a configuration comprising a drive plate portion and a boss adapted to releasably engage said channel and offset recess of the valve member in a single orientation.

5. A beverage dispense valve according to claim 4 wherein the bore of the body is has open ends, and the body defining at least one open end of the bore is provided with diametrically opposed cut-out portions adapted to receive a portion of the drive plate of the co-operating cover plate of the handle fork assembly such that in use, the cut-out portions define the degree of movement of the handle between the open and closed position of the valve member.

6. A beverage dispense valve according to any preceding claim wherein the handle fork assembly further comprises two releasably interlocking arms to retain the cover plates in contact with the valve member.

7. A beverage dispense valve according to any preceding claim wherein the cover plates of the handle fork assembly comprise an outer part-spherical surface such that in use, the outer surface of the cover plates and the valve body (other than the portions forming the inlet and outlet ports) has a substantially spherical profile.

8. A beverage dispense valve according to any preceding claim further comprising at least one spring-urged plug means located in the barrel to effect sealing at the inlet port when the valve is in the closed position.

9. A beverage dispense valve according to claim 7 wherein the spring means comprises a pair of plugs which fit slidably at either end of a passage in the barrel, and spring means between the two plugs urging them outwardly of the valve member to effect a sealing at the inlet port when the valve is in the closed position.

10. A beverage dispense valve according to claim 8 or 9 wherein the spring comprises a food grade elastomeric material.

11. A beverage dispense valve according to claim 10 wherein the spring comprises polychloroprene rubber.

12. A beverage dispense valve according to any one of claims 9 to 11 wherein each of the plugs of the valve member is provided with an alignment slot such that in use the plugs are assembled with their surfaces in alignment with the outer cylindrical surface of the valve member.

13. A beverage dispense valve comprising
(i) a body having a bore defining a cylindrical chamber therein and having a beverage inlet port and a beverage outlet port in communication with the chamber;
(ii) a rotatable valve member comprising a generally cylindrical barrel of plastics material rotatably mounted in the chamber in the body so as to be movable between open and closed positions of the valve, said barrel having a conduit therein to allow fluid to flow between the beverage inlet port and the beverage outlet port when the valve is in an open position, the external diameter of the barrel being minimally less than the internal diameter of the bore in the body;
(iii) handle means to rotate the valve member between the open and closed positions; and
(iv) sealing means receivable in a cylindrical passage in the valve member and comprising a pair of plugs which fit slidably at either end of the passage, and spring means between the two plugs urging them outwardly of the valve member; characterised in that the spring means comprises a food grade elastomeric material.

14. A beverage dispense valve according to claim 13 wherein the spring means comprises a polychloroprene rubber composition.
